(19) United States
(12) Patent Application Publication
(10) Pub. No.: US 2004/0104894 A1
(43) Pub. Date: Jun. 3, 2004

(54) Information processing apparatus

(76) Inventors: Yujin Tsukada, Tokyo (JP); Takeshi Hoshino, Kodaira (JP)

Correspondence Address: Mattingly, Stanger & Malur, P.C., Suite 370, 1800 Diagnoal Road, Alexandria, VA, 22314, US

(21) Appl. No.: 10/367,855

(22) Filed: Feb. 19, 2003

(30) Foreign Application Priority Data
Dec. 3, 2002 (JP) 2002-350625

(51) Int. Cl. G09G 5/00

(52) U.S. Cl. 345/168

(57) ABSTRACT

An information processing apparatus having a pointing device and a keyboard capable of quick pointing operation, in which no extra burden is imposed on the fingertip of the operator even after a protracted use. A second housing including a display unit and a first housing including a keyboard are foldable with each other through a connecting portion. A touch area having a beam sensor is arranged on the keyboard. The width of the touch area and the keyboard area is substantially equal to that of the display area of the display unit.

### BACKGROUND OF THE INVENTION

The present invention relates to an information processing apparatus comprising a pointing device and a keyboard, or in particular to an information processing apparatus comprising a first housing having a keyboard, a second housing having a display unit and a connecting portion for connecting the first and second housings to each other in foldable manner.

In an information processing apparatus, it is common practice to employ a method of operation and input using a keyboard and a mouse. This method of operation and input is intuitive and has the advantage accepted widely by many peoples. Nevertheless, it poses the problems described below.

A first problem is that the hand for the pointing operation with the mouse is required to be moved between the keyboard and the mouse while the operation alternates between the mouse and the keyboard, thereby leading to the loss of the working time. Also, an interruption of the work, though only for a short time, reduces the operating efficiency of the user. This is the problem often arising, for example, when preparing a document having a mixture of characters and figures.

A second problem is that an area is required to be secured for moving the mouse. This area is normally a flat surface in the size of about 200 mm by 150 mm and may be difficult to secure depending on the environment.

In order to solve these problems, there has been developed a widely-used notebook-sized information processing apparatus wherein a housing having a display unit and another housing having a keyboard are foldable through a connecting portion, and wherein a small pointing device (a track pad or a track ball) arranged on a palm rest formed on the front of the keyboard. Further, there has been proposed an information apparatus wherein the display unit includes a touch panel to permit the input operation either through the keyboard or the touch panel or wherein a transparent touch panel is mounted rotatably on the connecting portion for use as a normal touch panel on the front of the display unit or as a tablet on the keyboard.

The related conventional apparatuses are disclosed in JP-A-11-73277, JP-A-2000-112567, JP-A-2001-290584 and JP-A-2001-242956.

In moving the pointer over a long distance, however, the track ball or the track pad described above is required to be rubbed by a fingertip repeatedly and a quick manipulation is impossible. Also, this manipulation over a long time fatigues the finger.

On the other hand, the track point is for the pointing operation manipulating a stick. The direction and the distance covered by the pointer are controlled by the direction and the magnitude of the force in which the stick is tilted. The operation with this device cannot be performed intuitively, and a protracted use thereof causes a pain of the fingertips which impart pressure on the stick.

Further, in the apparatus having a touch panel arranged on the display unit, the finger is required to be moved between the keyboard and the touch panel. Also, fingerprints spot the display screen, or the tilt angle of the display unit is undesirably changed by the finger.

Furthermore, the touch panel of rotation type poses a similar problem to the apparatus having the display unit with a touch panel. This device also poses the problem that the key input is impossible at the upper part of the keyboard.

### SUMMARY OF THE INVENTION

The object of the present invention is to obviate these problems and to provide an easy-to-operate information-processing apparatus comprising a pointing device and a keyboard, in which quick pointing operation is possible and no burden is imposed on the fingertips of the operator after a long use.

According to this invention, in order to obviate the above-mentioned problems, there is provided an information processing apparatus so configured that a beam sensor is mounted on a keyboard having a plurality of keys. The beam sensor includes a touch area formed of an invisible light beam such as an infrared light beam or a laser on the keyboard, and can detect the position of a finger or the like inserted in the touch area. The beam sensor includes a transmitting unit for transmitting an invisible light beam such as an infrared light beam or a laser, a receiving unit for receiving the light beam and a pointing processing unit for calculating the position of the finger or the like inserted on the keyboard based on the distance covered, the time consumed and the direction followed by the light beam transmitted from the transmitting unit, before being detected by the receiving unit. Also, the beam sensor may alternatively be so configured as to include a reflector for reflecting the light beam transmitted from the transmitting unit so that the light beam thus reflected is detected by the receiving unit.

According to this invention, a touch area substantially as large as the keyboard area can be secured on the same keyboard area. Therefore, the operator can move the pointer by inserting the finger in the touch area and moving the inserted finger over the touch area in such a manner as if to manipulate the mouse. In addition, by depressing, through the touch area, each key of the keyboard arranged under the touch area, the same input operation can be performed as on the normal keyboard. In this way, according to this invention, the touch area and the keyboard area are arranged in vertical positions, and therefore the pointing operation and the keyboard operation can be carried out easily and quickly without any fatigue on the part of the fingertips or the like of the operator even after the use over a long time.

An input unit including a touch area and a keyboard area arranged in different vertical positions is suitably applicable to an information processing apparatus comprising a first housing having a display unit and a second housing having the keyboard, which are foldable through a connecting portion. In this information processing apparatus, the touch area is arranged above the keyboard, and a display unit is arranged with substantially the same width as the touch area and the keyboard area. The resultant fact that the touch area and the display area of the display unit are substantially equivalent to each other makes it possible to secure a superior sense of operation in almost one-to-one relation of the position and the distance coverage between the pointer in the display unit and the finger or the like in the touch area.

Also, even in the case where the keyboard is separated from the display unit or the information processing unit, the usability of the keyboard area having a plurality of keys also as a touch area makes it possible to secure a wide touch area. As a result, the size of the touch area almost equal or proximate to that of the display screen of the display unit can be secured. Therefore, a satisfactory sense of operation can be obtained with the one-to-one relationship between the position and the distance coverage between the pointer and the finger or the like.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B show the outer appearance of an information processing apparatus according to a first embodiment of the invention.

FIG. 2 is a block diagram showing an information processing apparatus according to the first embodiment of the invention.

FIGS. 3A and 3B are sectional views schematically showing an information processing apparatus according to the first embodiment of the invention.

FIGS. 4A and 4B are sectional views schematically showing an information processing apparatus according to the first embodiment of the invention.

FIGS. 5A and 5B are sectional views schematically showing an information processing apparatus according to the first embodiment of the invention.

FIG. 6 is a diagram showing the operating position of an information processing apparatus according to the first embodiment of the invention.

FIGS. 7A and 7B are diagrams showing the input operation of an information processing apparatus according to the first embodiment of the invention.

FIG. 8 is a flowchart for the tap operation of an information processing apparatus according to the first embodiment of the invention.

FIG. 9 is a flowchart of the operation of an information processing apparatus according to the first embodiment of the invention.

FIG. 10 is a flowchart of the operation of an information processing apparatus according to the first embodiment of the invention.

FIGS. 11A and 11B are diagrams for explaining the drag-and-drop operation using both hands.

FIGS. 12A and 12B are diagrams for explaining the cooperative operation using both hands.

FIGS. 13A and 13B are diagrams showing the outer appearance of a keyboard with a pointing device according to a second embodiment of the invention.

FIGS. 14A and 14B are diagrams for explaining a pointing device attached to the keyboard according to the second embodiment of the invention.

FIG. 15 is a diagram showing a system configuration of an information processing apparatus according to the second embodiment of the invention.

FIG. 16 is a diagram for explaining the operation of an information processing apparatus according to the second embodiment of the invention.

FIGS. 17A and 17B are top plan views showing a keyboard with a pointing device according to the second embodiment of the invention.

FIG. 18 is a top plan view showing a keyboard with a pointing device according to the second embodiment of the invention.

FIG. 19 is a diagram for explaining the operation of a pen tablet.

FIGS. 20A and 20B are diagrams for explaining a keyboard with a pointing device according to a third embodiment of the invention.

### DESCRIPTION OF THE INVENTION

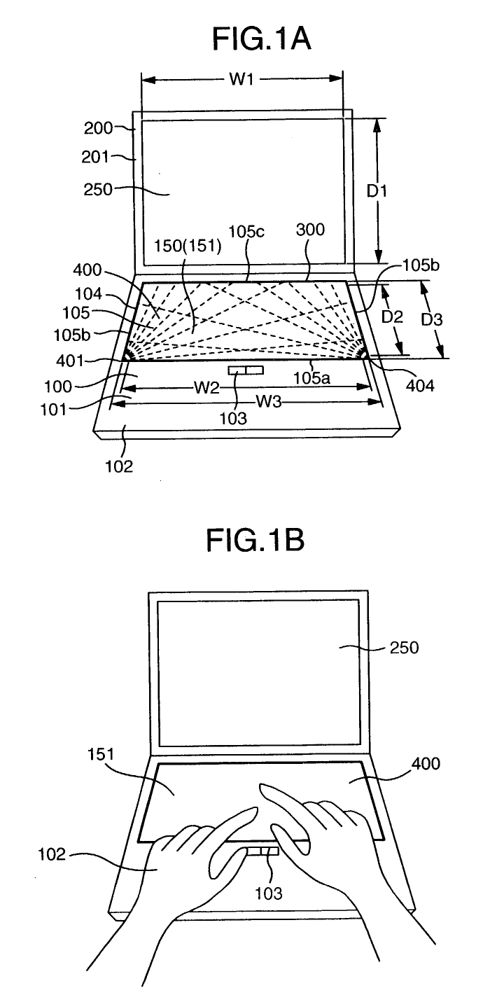

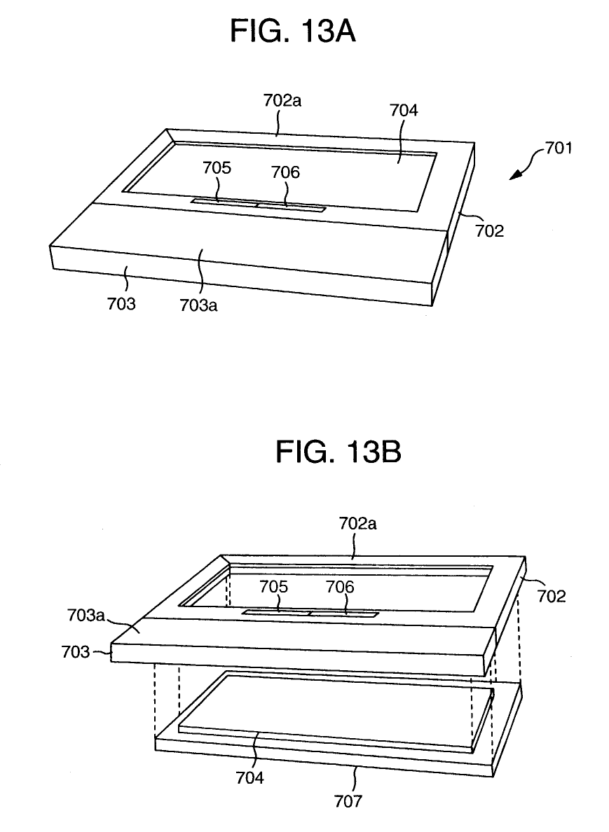

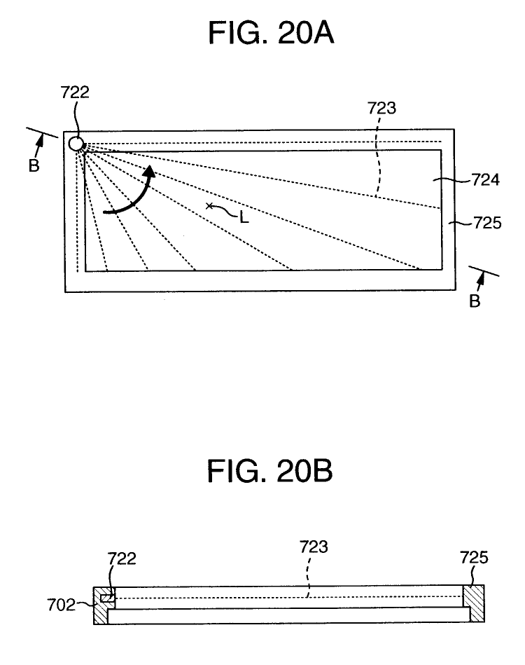

Embodiments of the present invention will be explained in detail below with reference to FIGS. 1A to 20B. FIGS. 1A to 12B show a notebook-sized information processing apparatus according to a first embodiment of the invention. FIGS. 13A to 19 show a desk-top information processing apparatus (keyboard-separated type) according to a second embodiment of the invention. FIGS. 20A and 20B show a keyboard with a pointing device according to a third embodiment of the invention.

### FIRST EMBODIMENT

First, with reference to FIGS. 1A and 1B, a general structure of an information processing apparatus according to the first embodiment will be explained. FIGS. 1A and 1B are diagrams showing the outer appearance of an information processing apparatus according to this embodiment, in which FIG. 1A is a perspective view of the apparatus in open state, and FIG. 1B a diagram showing the manner in which the apparatus is used in input mode.

In FIGS. 1A and 1B, reference numeral 1 designates the whole structure of a notebook-sized information processing apparatus. The information processing apparatus 1 comprises a thin first housing 100 having a keyboard 150, a thin second housing 200 having a display unit 250 and a connecting portion 300 adapted to connect the first housing 100 and the second housing 200 to each other in foldable way. The first housing 100 and the second housing 200 include a first hidden surface 101 and a second hidden surface 201, respectively, hidden by the respective housings with the second housing 200 folded through the connecting portion 300. The keyboard 150 is arranged on the first hidden surface 101, and the display unit 250 is arranged on the second hidden surface 201.

The first housing 100 includes therein a storage unit and a processing unit (CPU) for controlling the information processing apparatus 1 as a whole. The keyboard 150 of a substantially horizontal rectangle is arranged on the rear part of the first hidden surface 101 of the first housing 100. A palm rest 102 having a flat surface is arranged on the front part of the first hidden surface 101. Also, a pair of click buttons 103 are arranged on the central part of the palm rest 102 nearer to the keyboard.

A significant feature of this embodiment lies in that a substantially rectangular horizontal opening 104 is formed in the first hidden surface 101, the obverse surface of the opening 104 has a touch area 400 formed of infrared light beams, and that a keyboard area 151 including the keyboard 150 is arranged as a layer under the touch area 400.

Specifically, according to this embodiment, a beam sensor 401 is arranged on a frame 105 around the opening 104 thereby to form the touch area 400. The beam sensor 401 may be an infrared touch panel device of any well-known type. This embodiment, however, employs an infrared touch panel device for detecting a touched position based on the principle of triangulation which readily contributes to higher compactness and accuracy.

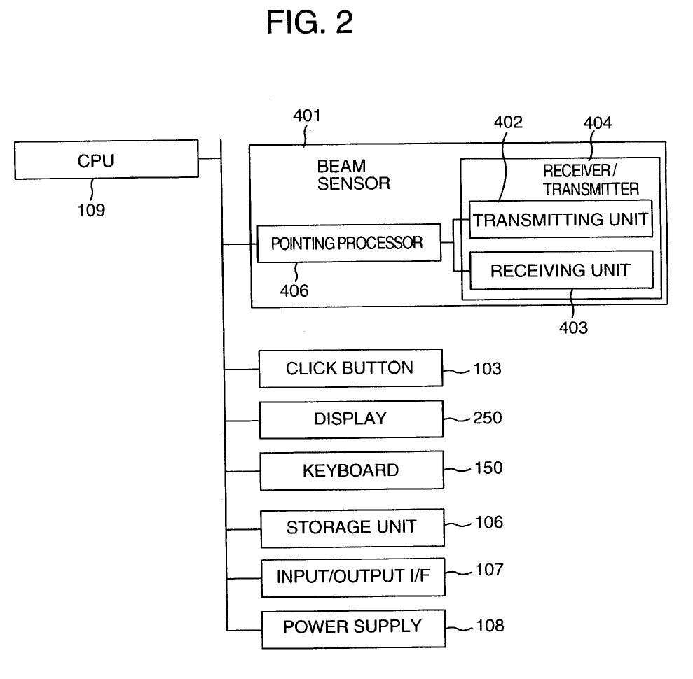

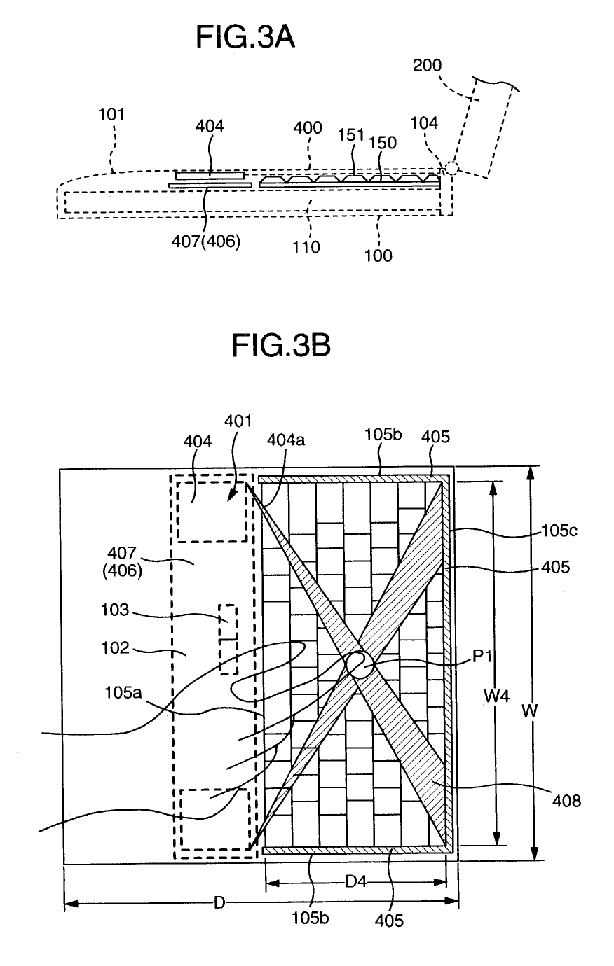

The beam sensor 401, as shown in FIGS. 2, 3A and 3B, includes a pair of receiver/transmitters 404 each in an integrated structure of a transmitting unit 402 having a LED light source or the like for transmitting the infrared light and a receiving unit 403 having a photo detector such as an image sensor for receiving the infrared light, a reflector 405 for reflecting the infrared light from the transmitting unit 402 in the same direction as the incident light, and a pointing processing unit 406 for detecting, using the receiving unit 403, the direction in which the infrared light transmitted from the transmitting unit 402 is interrupted by the finger or the like and thus calculating the position of the finger or the like inserted in the touch area 400 based on the principle of triangulation. The receiver/transmitters 404, though not shown, employ such a configuration that a half mirror or a tunnel mirror is additionally arranged before an image-forming lens in such a manner that the optical axis of the transmitting unit 402 coincides with that of the receiving unit 403. In spite of the employment of a configuration in which the light beam is interrupted with a finger, any other pointing means than the finger may of course be employed with equal effect.

Returning to FIGS. 1A and 18, according to this embodiment, a pair of the receiver/transmitters 404 are arranged on the two sides of the part of the substantially rectangular opening 104 nearer to the operator. The infrared light is transmitted radially from the receiver/transmitters 404, and the infrared light beams reflected from reflectors 405 arranged on the opposed sides 105b, 105c of the opening 104 are received by the receiver/transmitters 404. The reflectors 405 have the function of reflecting the incident light in the same direction (retroreflection material). Therefore, the pointing processing unit 406 can detect the position of a finger or the like inserted in the touch area 400 by calculating the particular position based on the principle of triangulation from the result of detecting, by the two receiver/transmitters 404, the direction of the shadow not reflected by the finger or the like.

On the other hand, the keyboard 150 is arranged in a position not contacted by the touch area 400, i.e. in a position where the keytops thereof are located one step lower than the first hidden surface 101. According to this embodiment, each keytop of the keyboard 150 is configured to have a flat surface, and the interval between the surface of the touch area 400 and the keyboard area 151 configured of the keytop surface of the keyboard 150 is set to not more than 1 mm.

As described above, in the information processing apparatus 1 according to this embodiment, as shown in FIG. 1B, both characters and numerals can be input using the keyboard 150 (the keyboard area 151) with a similar operation to that of the ordinary notebook-sized information processing apparatus by placing the two wrists on the palm rest 102. At the same time, the pointing operation can be performed using the touch area 400 superposed on the keyboard area 151 and having substantially the same size as the keyboard area 151.

Therefore, the operator can move the pointer on the display screen, in the same way as if the mouse is operated, by inserting his finger in the touch area 400 and moving it over the touch area 400. In this touched state, a predetermined function can be selected on the display screen by the click buttons 103 or the tap operation described later. In this touched state, the normal input operation on the keyboard 150 can be carried out by depressing the keys of the keyboard 150 arranged under the touch area 400.

Also, according to this embodiment, in view of the fact that the touch area 400 and the keyboard area 151 are arranged in upper and lower stages, respectively, the pointing operation and the operation of inputting characters or the like can be performed without leaving the hands from the palm rest 101. Thus, the input operation is facilitated while at the same time making possible quick pointing operation. Further, a stress is not imposed on the fingertips or the like of the operator even after the protracted pointing and keyboard operations.

In addition, the touch area 400 can be formed in substantially the same size as or larger than the keyboard area 151. Therefore, at least the width W3 of the touch area 400 can be set to substantially the same size as the width W1 of the display unit 250. As a result, the position and the distance coverage of the pointer in the display area can be set substantially in one-to-one correspondence with the position and the distance coverage of the finger or the like in the touch area, thereby leading to a superior sense of manipulation.

Also, according to this embodiment, the absolute coordinate is used for designating the pointing position. Specifically, once a given coordinate is designated in the touch area 400, a corresponding coordinate on the display area is uniquely determined. Therefore, the pointer is not required to be moved continuously. This suits the operation with both hands. Especially in view of the fact that the keyboard is originally manipulated with both hands, the pointing operation can be performed in natural fashion using the touch area 400 above the keyboard area 151 configured on the assumption of two-handed operation.

Now, the information processing apparatus 1 according to this embodiment will be explained in more detail with reference to FIGS. 1A to 12B.

First, referring to FIG. 2, the system configuration of the information processing apparatus 1 will be described. FIG. 2 is a block diagram showing the information processing apparatus 1. According to the embodiment shown in FIG. 2, the information processing apparatus 1 comprises the beam sensor 401 for performing the pointing operation, the click buttons 103 for outputting the defined information on the pointer displayed on the display screen, the display unit 250 for displaying various images, the keyboard 150 including a plurality of keys, a storage unit 106 configured of a hard disk or the like, an input/output I/F (interface) 107 making possible the connection with external equipment and a power supply unit 108. All of these component parts are connected to a processing unit (hereinafter referred to as the CPU 109) for controlling the information processing apparatus 1 in overall fashion.

The beam sensor 401 includes the pointing processing unit 406 and a receiving unit 403 and a transmitting unit 402 connected to the pointing processing unit 406. The pointing processing unit 406 controls the receiver/transmitter 404 configured of the receiving unit 403 and the transmitting unit 402, calculates the position of the finger or the like in the touch area 400 based on the signal from the receiver/transmitter 404, monitors the time during which the touch area 400 is touched, and in the case where the touch area 400 is touched for shorter than a predetermined time, transmits the same signal as the click buttons 103. According to this embodiment, therefore, the same operation can be designated as the operation of the click buttons 103, for example, by touching a predetermined position of the touch area for a short length of time.

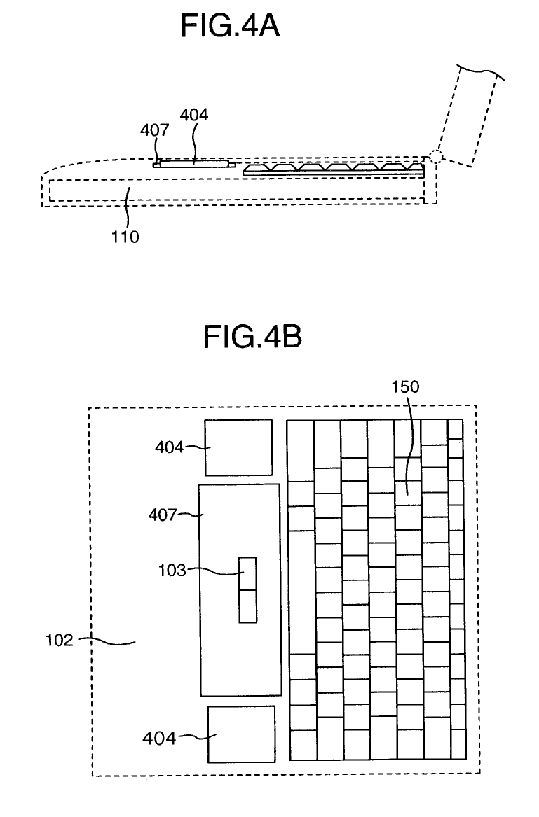

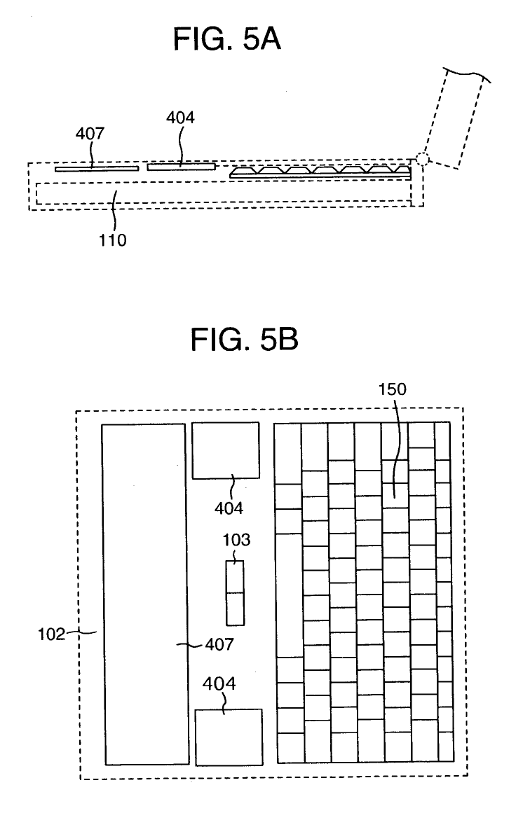

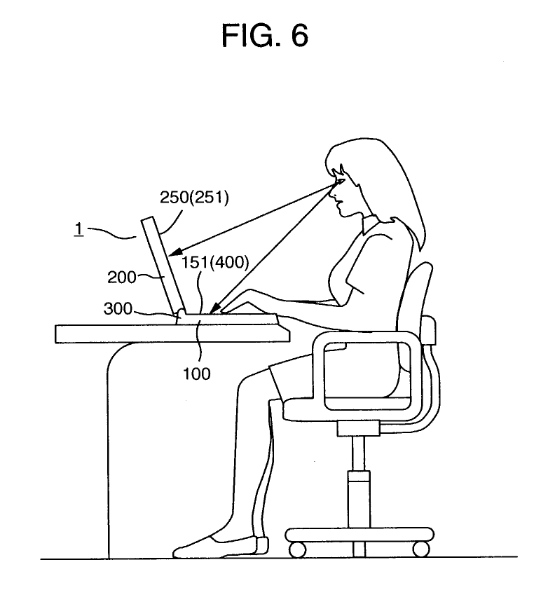

Next, with reference to FIGS. 3A to 5B, a specific structure of the light beam sensor 401 according to this embodiment will be explained in more detail. FIGS. 3A to 5B are sectional views schematically showing the information processing apparatus, in which FIGS. 3A, 4A, 5A are each a central longitudinal sectional view showing a state in which the second housing 200 is open, and FIGS. 3B, 4B, 5B are each a plan view showing a layout configuration of the first hidden surface 101. FIGS. 3A and 3B are diagrams for explaining the information processing apparatus 1 according to this embodiment, and FIGS. 4, 5 show layout configurations of the beam sensor 401 in other applications.

First, refer to FIGS. 3A and 3B. In this embodiment, the first housing 100 is configured of an upper case (not shown) constituting the upper portion and a lower case (not shown) making up the lower portion. A plurality of internal units 110 including a main board making up a CPU 109 and a storage unit 106 are arranged in the equipment housing covered by the upper and lower cases. The upper portion constituting the upper case is formed with the first hidden surface 101 covered by the second housing 200. The whole of the first hidden surface 101 is substantially flat and smooth. A rectangular opening 104 for containing the keyboard 150 is formed at the rear part of the first hidden surface 101. The opening 104 having a width W4 is formed over the full width W of the first hidden surface 101, and the longitudinal depth D4 thereof is about one half of the depth D of the first hidden surface 101. The front portion of the first hidden surface 101 is formed with the palm rest 102 utilizing the smooth flat surface.

The keyboard 150 with a plurality of keys arranged according to a specific rule is located in the opening 104. The keyboard 150 is arranged above the internal units 110 in such a manner that the keyboard area 151 configured of the top surface of each key is located one step lower than the obverse surface of the first hidden surface 101. The beam sensor 401 is arranged in the portion around the opening 104 between the keyboard area 151 and the first hidden surface 101.

According to this embodiment, as shown in FIG. 3, the thin receiver/transmitters 404, the pointing processing unit 406 and the thin pointing control board 407 are arranged between the internal units 110 and the palm rest 102. Transmission windows 404a of the receiver/transmitters 404 are arranged on the peripheral parts of the opening 104 between the keyboard area 151 and the first hidden surface 101. As shown in FIG. 3B, for example, this embodiment is such that the pointing control board 407 is formed in a lateral rectangle, and the receiver/transmitters 404 mounted on the two longitudinal sides of the pointing control board 407, together with the click buttons 103 arranged at the central part thereof, form a single sensor unit. According to this embodiment, therefore, the fact that the sensor unit is mounted on the inner surface of the upper case sets the transmission windows 404a in position on the two sides of a single edge of the opening 104 nearer to the operator, thereby contributing to an improved mountability. Also, an unused space existing under the palm rest 102 is reduced by forming the palm rest 102 with an inclined surface for an improved operability thereof.

The reflector 405 is mounted on the side 105c of the opening 104. In this configuration, as shown in FIG. 3A, the touch area 400 is formed above the keyboard area 151. For the convenience of key operation, the keyboard area 151 is set inside of the touch area 400 or to the same size as the touch area 400. Specifically, as shown in FIG. 1A, the width W2 of the keyboard area 151 is equal to or smaller than the width W3 of the touch area 400.

According to this embodiment, as shown in FIG. 3B, assume that the finger making up a designator is not inserted in the touch area 400. The infrared light beams transmitted from the receiver/transmitters 404 are passed over the touch area 400, and after being reflected on the reflectors (retroreflective members) 405, return to the receiver/transmitters 404 through the light paths reverse to those of the incident infrared light beams. As a result, the pointing processing unit 406 determines that the touch area 400 is not touched.

Once the finger or the like is inserted at the position P1 in the touch area 400, on the other hand, a part of the infrared light paths is interrupted so that the infrared light fails to return to the receiver/transmitters 404. By detecting the direction in which the resultant shadow 408 is formed, the direction in which the finger or the like interrupting the infrared light is located can be detected. The receiver/transmitters 404 are arranged on both sides of the edge 105a nearer to the operator, and therefore the coordinate of the designated position P1 can be calculated according to the principle of triangulation from the direction of P1 detected by the two receiver/transmitters 404.

The reflectors 405 are made of a well-known retroreflective material having such a reflection characteristic that the incident light returns straight along the direction of incidence. The retroreflective member is generally composed of a retroreflective sheet embedded with a multiplicity of tiny transparent glass beads, a small corner cube prism or a white component member having a high reflectivity.

FIGS. 4A, 4B, 5A and 5B show applications of other layout configurations of the pointing processing unit 406 and the receiver/transmitters 404. According to the embodiment shown in FIGS. 4A and 4B, the pointing control board 407 of the pointing processing unit 406 and the receiver/transmitters 404 are separated from each other, so that the receiver/transmitters 404 are arranged on both sides of the pointing control board 407. With this configuration, the separation between the pointing control board 407 and the receiver/transmitters 404 improves the maintainability.

According to the embodiment shown in FIGS. 5A and SB, the pointing control board 407, the receiver/transmitters 404 and the click buttons 103 are arranged substantially equidistantly between the palm rest 102 and the internal units 110. In this embodiment, for example, the laterally rectangular pointing control board 407 is arranged in front of the palm rest 102, the receiver/transmitters 404 behind the two sides of the pointing control board 407, and the click buttons 103 between the receiver/transmitters 404. According to this embodiment, each device can be arranged with a sufficient margin in the space between the palm rest 102 and the internal units 110, and therefore the change, if any, of the size of a given device can be accommodated immediately.

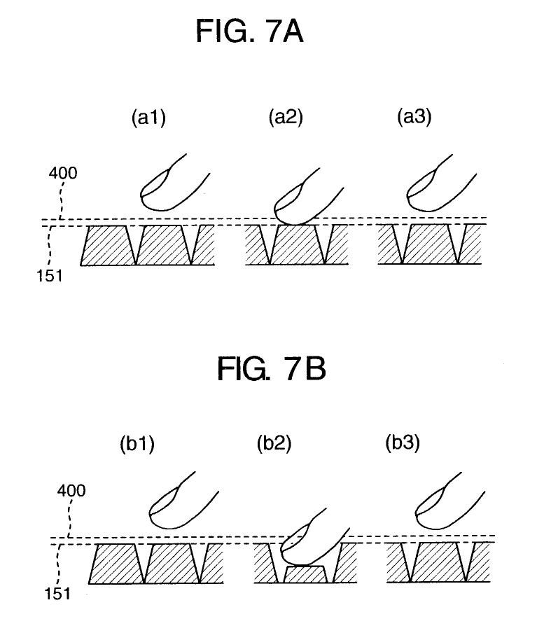

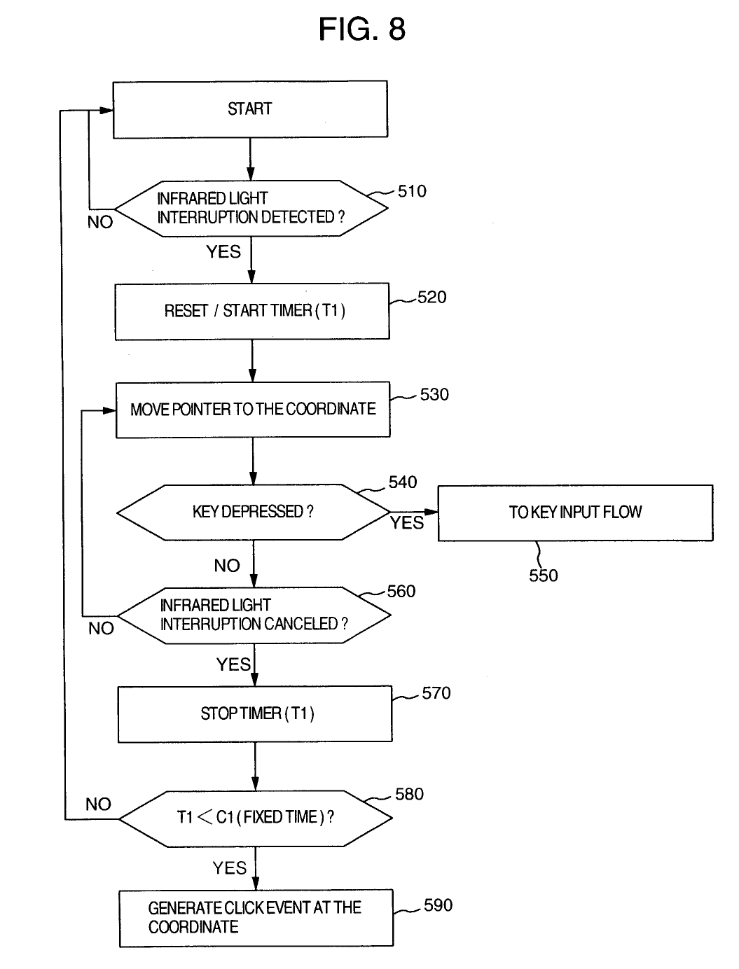

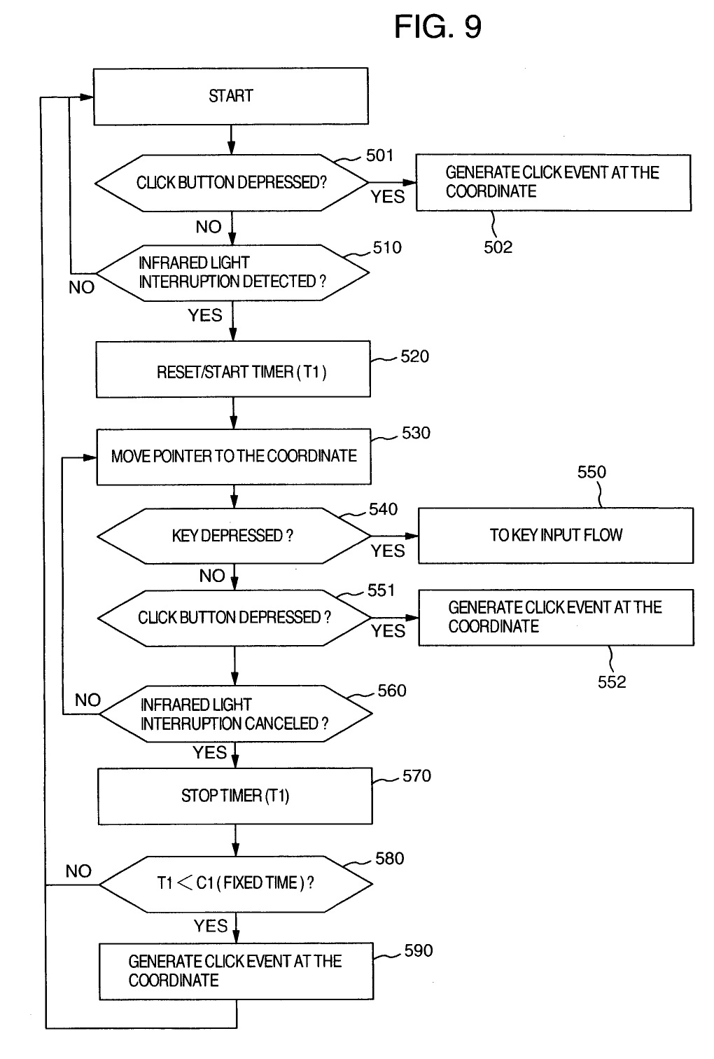

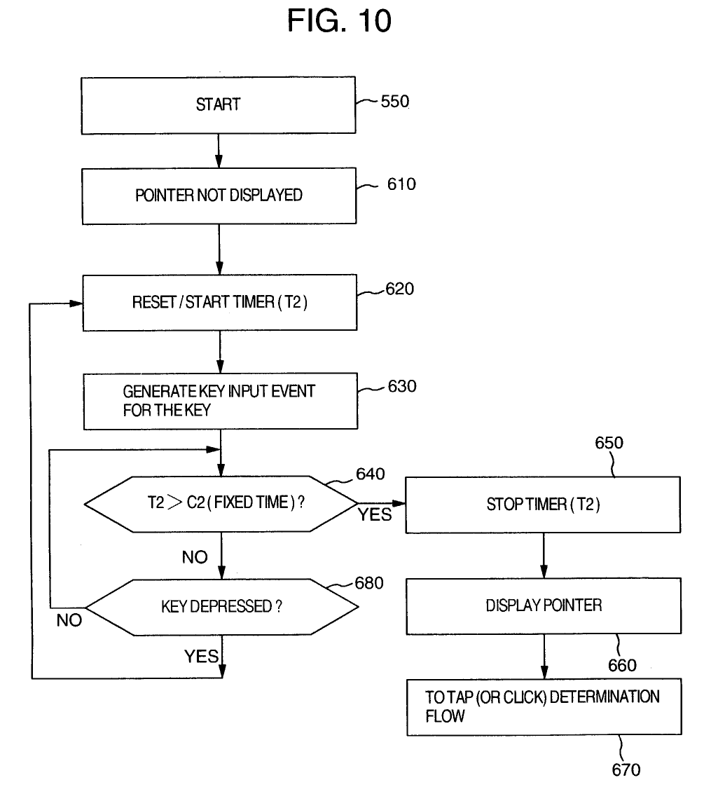

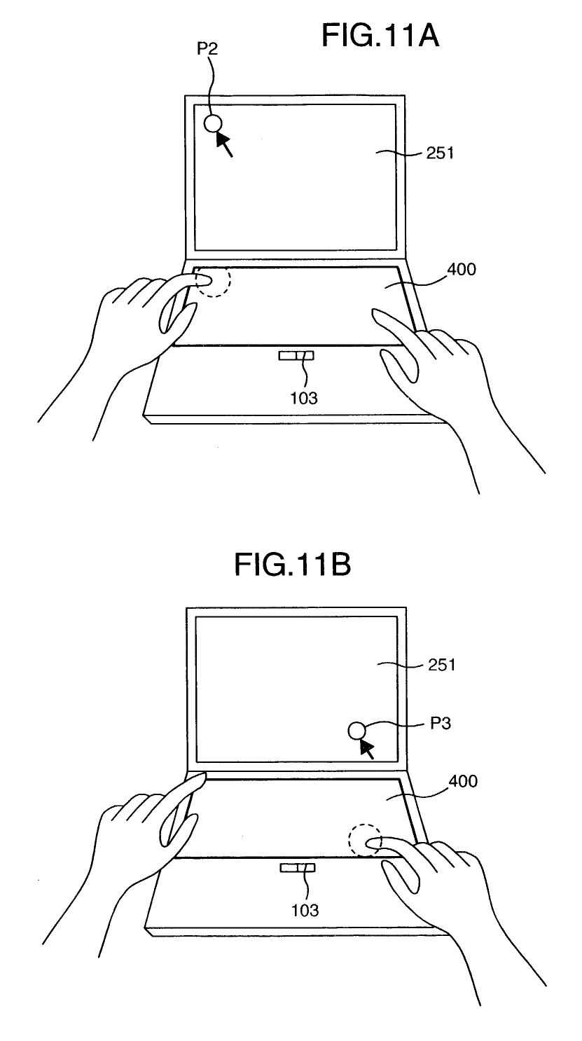

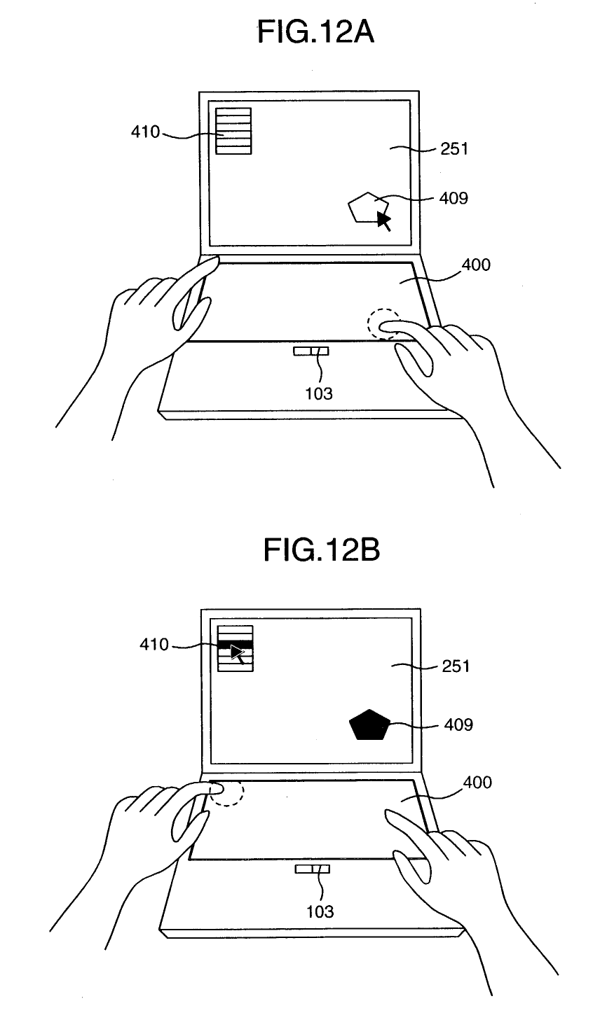

Next, with reference to FIGS. 1A, 1B and 6 to 13B, a method of operating the information processing apparatus 1 according to this embodiment will be explained. FIG. 6 is a diagram showing the position in which the information processing apparatus 1 is operated on a desk. FIGS. 7A and 7B are diagrams showing the input operation, in which FIG. 7A is a diagram for explaining the operation in the touch area 400, and FIG. 7B a diagram for explaining the operating position in the keyboard area 151. FIG. 8 is a flowchart for the tap operation in the touch area 400. FIG. 9 is a flowchart for the operation of the click buttons 103. FIG. 10 is a flowchart for the operation of displaying the pointer in the keyboard area 151. FIGS. 11A and 11B are diagrams for explaining the drag-and-drop operation with both hands of an operator. FIGS. 12A and 12B are diagrams for explaining the cooperative operation of both hands.

First, the embodiment shown in FIGS. 1A and 1B represents an information processing apparatus 1 having a high portability with two housings 100, 200 foldable through the connecting portion 300. When using this information processing apparatus, as shown in FIG. 1A, the second housing 200 is opened to expose the two hidden surfaces 101, 201, thereby making it possible to operate the display unit 250 and the keyboard 150 arranged on the hidden surfaces. In operation, a power switch not shown is turned on to enable the CPU 109 to energize the operating system stored in the storage unit 106. In this way, the window system is activated thereby to display a menu display screen (not shown) of the window system on the display unit 250. Once the menu display screen is displayed, the pointer is displayed at the position where the power supply is turned off on the previous occasion.

In this information processing apparatus 1, with the wrists or the neighboring portions of the both hands placed on the palm rest 102, the keyboard area 151, the touch area 400 and the click buttons 103 can be manipulated with the wrists and the neighborhood thereof of the both hands kept on the palm rest 102.

Also, as shown in FIG. 1A, the information processing apparatus 1 according to this embodiment is such that the width W3 of the touch area 400 is set to substantially the same size as the width W1 of the display unit, and the depth D3 of the touch area 400 is set to a size reachable by the hand using the palm rest 102. Considering the matching between the touch area 400 and the display area 251 capable of display in the display unit 250, the width W3 and the depth D3 of the touch area 400 should be set to the same size as the width W1 and the height D3, respectively, of the display unit 250. In this way, it is possible that the size of the touch area 400 corresponds in one-to-one relation with the size of the display area 251, so that the touch position in the touch area 400 can be set to the display position of the pointer.

Generally, however, the notebook-sized information processing apparatus of this type is used on a desk as shown in FIG. 6. In this case, the operator manipulates the keyboard 150 visually in a diagonal direction from this side, while setting and using the display unit 250 in such a position that the display surface of the display unit 250 is rendered orthogonal to the eye line by manipulating the connecting portion 300 and thus adjusting the angle of the second housing 200. If the display area 251 in a vertical position where the height is visible and the touch area 400 in a horizontal position where the depth is hard to recognize are to be able to be recognized by eyes, therefore, the depth D3 of the touch area 400 is required to be larger than the height D1 of the display area 251. The touch area 400 having a large depth D3 requires an extensive movement of the hands operating the apparatus, resulting in a deteriorated operability. In view of this, according to this embodiment, the depth D3 of the touch area 400 is set to a size reachable with comparative ease with the wrists and the neighborhood thereof placed on the palm rest 102.

In the mode of operation shown in FIG. 6, on the other hand, the lateral lengths W3, W1 of the touch area 400 and the display area 251 can be clearly recognized by the operator regardless of his operating position. According to this embodiment, therefore, the lateral lengths W3 and W1 of the touch area 400 and the display area 251 are rendered substantially coincident with each other so that the apparatus can be operated while visually confirming the pointer and the touch position in one-to-one relation with each other. Further, according to this embodiment, the display area 400 and the touch area 251 (the keyboard area 151) are fixed with the same width. Even the operator not well accustomed to the blind touch operation can easily grasp the position of the finger or the like in the touch area 400 and the keyboard area 151 based on the display area 251 for an improved operability.

Specifically, many of the conventional pointing devices such as the mouse used with the keyboard are operated on a relative amount of an input distance coverage. Therefore, the operator is always required to look for the pointer position on the screen before starting the operation of moving the pointer. According to this embodiment, in contrast, the coordinate position on the display area 251 corresponding to the coordinate position on the touch area 400 is uniquely determined, and therefore the pointer can be moved using the absolute coordinate. As a result, the operator can easily grasp the relation between the coordinate on the touch area 400 and the coordinate on the display area 251. Thus, the object on the display area 251 can be selected directly on the touch area 400, thereby shortening the operation time.

Especially, the beginners usually keystroke while watching the keyboard. Once he is accustomed to the input operation, however, what is called “the blind touch” in which characters are input without watching the keyboard becomes possible. Similarly, according to this embodiment in which the touch area 400 equivalent to the keyboard area 151 is arranged in a form corresponding to the display area 251 with the absolute coordinate, the operator is easily accustomed to the pointing operation like the keystroke. As a result, the blind pointing operation on the display area 400 can be easily carried out without watching the touch area 400.

Even in the case where it is difficult to form the display area 251 and the touch area 400 in the same size due to the relative sizes of the display area and the keyboard, the use of the absolute coordinate makes it possible to easily grasp the correspondence between the coordinate on the touch area 400 and the coordinate on the display area 251. Therefore, the operator is easily accustomed to the blind pointing operation. In that case, the correspondence between the two coordinates can be easily grasped intuitively by arranging the two coordinate areas in a similar shape. Also, in the the touch area 400 is formed as a laterally long area in which the fingers of the both hands are movable, the operating efficiency is improved of the operation with both hands.

Next, the basic operation of this embodiment will be explained with reference to FIGS. 7A and 7B.

### Pointer Display

First, in FIG. 7A, (a1) designates the state not in operation, in which case the infrared light is not interrupted by fingertip, (a2) designates the state in which the fingertip is touched on the touch area 400 and the infrared light is interrupted. Let this state be called “the touch-down”. In the touch-down state, no key on the keyboard area 151 is depressed. When the infrared light is interrupted by the touch-down, the beam sensor 401 calculates the touch-down position, and outputs a position signal to the CPU 109, which in turn moves the pointer to a corresponding position on the display area 251. In the case where the fingertip is moved in touch-down mode, the movement is monitored by the beam sensor. Therefore, the CPU that has received the signal causes the pointer on display in the display area to move with the fingertip. The distances covered by the fingertip and the pointer are in one-to-one relation along the width W1 and W3, while the distance coverage along the longitudinal direction (depth D3) of the touch area 400 and along the longitudinal direction (height D1) of the display area are determined from the ratio between the two distance coverage.

From the touch-down mode, the fingertip is lifted up into the state (a3) (the same state as a1). Let this state be called “the lift-off”. The lift-off operation ceases the interruption of the infrared light in the touch area. The CPU that has received the signal, therefore, causes the pointer on display to be displayed as it is at the lift-off position in the display area 251.

According to this embodiment, the pointer is displayed at the lift-off position. By appropriate setting, however, the pointer may be moved to a preset home position or may not be displayed at all. In the case where the home position is set outside of the display area 251, the same effect can be obtained as non-display.

### Tap Operation

Upon detection of the touch-down, the beam sensor starts a timer and monitors whether a lift-off occurs within a predetermined time, say, 0.5 seconds. In the case where a lift-off occurs within the predetermined time, the same signal as if a click button is operated is output to the CPU 109. This operation of lift-off within a predetermined time from the touch-down is called “the tap operation” for the present purpose. This tap operation has a similar function to the operation of selecting a click button of the mouse. For selecting an object (such as a select button) displayed at a predetermined position in the display area 251, for example, assume that the tap operation is performed at the particular predetermined position of the object (such as a select button). A signal indicating that the selection is carried out at the particular predetermined position is output to the CPU 109. The CPU 109 determines that the object (such as the select button) has been selected, based on the screen data of the display area 251 and the output signal of the beam sensor 401, and changes the display or performs the operation based on this determination. According to this embodiment, an operation similar to the tap operation can be performed by operating the click buttons 103.

Also, according to this embodiment, in the case where the tap operation is carried out continuously with the same object, it is determined that an operation similar to the double click of the mouse such as the execute operation has been carried out.

### Drag Operation

According to this embodiment, the “drag operation” with the mouse moved while keeping a click button depressed can be performed. The drag operation is used for relocation of a file or enlargement/reduction and relocation of a window. In this embodiment, assume that an object (such as a select button) is tapped for selection and the same object is touched down on again, after which no lift-off occurs within a predetermined time. In that case, the drag operation is assumed to be started (The double click or the repeated touch-down is assumed in the case where the lift-off occurs with a predetermined time).

### Drop Operation

According to this embodiment, it is determined that the “drop operation” has been performed in which an object being dragged is tapped again at a predetermined position and released at the tapped position. In this embodiment, therefore, the “drag-and-drop” operation can be accomplished in such a manner that an object displayed in the display area 251 is tapped, touched down again, moved in this touch-down state, and tapped again at the destination. The object being dragged, if lifted off before being tapped at the destination, is held at the lift-off position. In this state, however, the object is not tapped and therefore the select mode is maintained. Therefore, the object in select mode can be dragged again by touch-down.

### Key Input Operation

Next, reference is had to FIG. 7B. According to this embodiment, in the case where the operation is performed in the keyboard area 151, the pointer designated in the touch area 400 is always displayed. Assume, for example, that only the above-mentioned basic operation in the touch area 400 is available. Upon transfer from the state (b1) involving no operation to state (b2) in which the key input is made. A touch-down occurs, and therefore the pointer is displayed at the touch-down position. Further, after the key input is accepted, assume that transfer is made to state (b3). The lift-off occurs, and the pointer is displayed at the same position. In the case where the key input is conducted continuously, on the other hand, the same state is obtained as if the tap operation is carried out. In this case, assume that only the basic operation is used in the touch area 400. Each time a key is depressed as a key input operation, a corresponding position of the touch area 400 would be considered to have been tapped. Therefore, the input position moves in four directions and the normal key input becomes impossible.

According to this embodiment, it is determined that the tap operation is not performed in the case where a key in the keyboard area is depressed during the time between touch-down and lift-off. The resultant fact that the key input position remains unchanged makes possible normal input operation. Also, the movement of the pointer in four directions at the time of key input is an eyesore. Therefore, the pointer is not displayed for a predetermined time, say, one second after key input. As a result, the pointer is not displayed during the continuous key input, and displayed again upon complete key input.

Next, referring to FIGS. 8 to 10, the flow of the basic operation will be explained in more detail. In FIG. 8, as long as power is on, the beam sensor 401 constantly monitors whether the touch-down occurs or not (step 510). Under this condition, the pointer is displayed at the preceding lift-off position.

When the finger or the like touches down in the touch area 400, the beam sensor 401 starts the timer and counts the time consumed before lift-off (step 520). Upon complete transfer from touch-down to lift-off, the timer is stopped (step 560), and it is determined whether the time (T1) consumed from touch-down to lift-off is shorter than a preset time length (C1) (step 580). In the case where the consumed time (T1) is shorter than the preset time (C1), it is determined that the tap operation is performed, and a click event (the operation of the click buttons 103) is generated at the corresponding coordinate. In the case where the consumed time (T1) is longer than the preset time (C1), on the other hand, the pointer is displayed at the lift-off position and the process proceeds to step 610.

In the case where the touch-down position is changed during the time from touch-down to lift-off, the corresponding pointer is moved with the change of the touch-down position (step 530). In the case where a key in the keyboard area 151 is depressed during the touch-down operation (step 540), on the other hand, the process proceeds to the key input flow in FIG. 10 (step 550).

FIG. 9 shows the operation flow for dual purpose of the operation of the click buttons 103 and the tap operation. This embodiment represents a case in which the tap operation and the operation of the click buttons 103 double as each other. The same steps as those for the operation shown in FIG. 8 are designated by the same reference numerals, respectively.

In FIG. 9, suppose that a click button 103 is depressed with power on (step 501). A click event is generated at the coordinate position where the pointer is displayed (step 502). In the case where a select button is displayed at the position where the pointer is displayed, for example, it is determined that the particular select button is selected and the operation set for this select button is executed. In the case where there is no event to be selected at the position where the pointer is displayed, on the other hand, the operation involved is canceled.

In lift-off mode, the beam sensor 401 constantly monitors whether the fingertip or the like touches down and interrupts the infrared light (step 510). In the case where a touch-down occurs from this state (step 510), as in the case of FIG. 8, the time consumed before lift-off starts to be counted, and upon complete lift-off (step 560), the process proceeds to steps 570, 580, 590.

Once the touch-down position moves from the touch-down state described above, the operation of step 530 is executed, and upon depression of a key, the operation of steps 540, 550 is performed. In the case where a click button is depressed during the touch-down, the process proceeds to step 552 thereby to generate a corresponding click event.

According to this embodiment, the click button operation doubles as the tap operation, and therefore the two operations can be used selectively if desired by the operator. Nevertheless, the click button operation and the tap operation are not necessarily doubled as each other, but one of the operations alone may be effectively used. In the operation flow shown in FIG. 9, for example, the operation of the click buttons 103 can be constituted as an exclusive one by deleting steps 520, 570, 580, 590.

FIG. 10 shows the operation flow with the process passed to the key input step 550. In FIG. 10, the initial state is the one in which a predetermined key in the keyboard area 151 is depressed. According to this embodiment, once a key in the keyboard area 151 is depressed, the pointer that has been displayed by touch-down ceases to be displayed (step 610). At the same time, the timer is started to count the time (T2) consumed from the end of key input (step 620). Then, a key input event of the corresponding key is generated (step 630). While the timer is counting, whether a preset time (C2) has elapsed or not is monitored, while at the same time monitoring whether the next key is depressed within the consumed time C2 (step 680). In the case where the next key is depressed within the preset time, the process proceeds to step 620, in which the timer is reset and starts counting again (step 620).

Upon the lapse of the preset consumed time (C2), the timer (T2) ceases to count and the pointer is displayed at the lift-off position (step 650). In the case where the touch-down state prevails in step 640, however, the pointer is not displayed. In the case where the next operation is performed in step 660, the process proceeds to step 670.

Next, the drag-and-drop operation with both hands will be explained with reference to FIGS. 11A and 11B. In this embodiment, the object being dragged can be instantaneously moved by using the basic operation described above. Also, according to this embodiment, no drop operation is performed before the next tap operation after starting the drag operation. Assume that the finger being dragged is lifted off at a given position and a finger of the other hand is touched down at another position in the display area 251. The object is instantaneously moved to the particular position. Thus, the object dragged can be instantaneously moved to the target position by bringing the finger for starting the drag operation near to the object while at the same time keeping a finger of the other hand standing by at the target position.

FIG. 11A shows a state in which an object capable of being dragged is displayed at the upper left position P2 in the display area 251. FIG. 11B shows a state in which the object is moved to the lower right position P3 in the display area 251 by the drag-and-drop operation.

In the conventional drag-and-drop operation using the mouse, the pointer is moved to the object position P2 using the pointer first of all. In the process, the mouse is required to be moved to the position P2 by being slid several times on the desk for moving the pointer to the previous position P2 before the intended movement. Next, the pointer is set to the object at the position P2, and a click button is depressed for selection. With the click button thus depressed, the mouse can be moved to the lower right object position P2 by being slid several times on the desk. The pointer is always displayed on the display area 251 thereby to display the locus of movement of the pointer (including the object).

According to this embodiment, in contrast, the position of the touch area 400 corresponding to the object position P2 in the display area 251 is tapped with the left hand, followed by another touch down. Upon the lapse of a predetermined time, the object at the position P2 can be made ready for drag operation. Under this condition, the position of the touch area 400 corresponding to the target position P3 is tapped with the right hand. In this way, the object can be instantaneously moved to the position P3. Assume, for example, that the object at the position P2 cannot be tapped with the left hand. After touch-down in the vicinity of the object at the position P2, the pointer on display is set to the object P2 and the position P2 is tapped. In this way, fine adjustment is made possible. In similar fashion, in the case where the drop position requires a considerable accuracy, a touch-down in the vicinity of the position P3 where the drop is to be made with the right hand causes the object P3 to be moved and displayed at the touch-down position. In this touch-down state, the mouse is dragged to position and the tap operation performed at the position P3 to be defined. In this way, the object is defined at the position P3 thus tapped. Further, the click buttons 103 may be operated instead of the tap operation.

Assume that the tap operation is not performed but the touch-down operation at the destination, and upon the lapse of at least a predetermined time after the tap operation, the lift-off is carried out. Then, the object that has moved to the destination is displayed at the particular destination in select mode. The position is not fixed in selected mode, and therefore a touch-down at another position in the touch area moves the object instantaneously to another position.

Further, as in the prior art, the process of movement can be displayed also by the pointer. After the object is set in select mode at the position P2, for example, the touch-down is carried out again at this object again and the mouse is dragged directly to the target position P3 at which the tap operation is carried out.

As described above, the conventional drag-and-drop operation is a continuous series of processes including the dragging from the selection of an object to the drop operation. According to this embodiment, on the other hand, the drag operation is omitted from the drag-and-drop operation to save the operation requiring time and patience (the operation of moving while depressing the click button) and thus to shorten the operation time. Further, since the drag operation is omitted, the drag-and-drop operation can be divided into two operations of “select” and “drop”. Thus, the burden of the two operations can be shared by the both hands. According to this embodiment, therefore, the operation with the both hands makes possible the operation in one-to-one relation of the touch area 400 and the corresponding display area 251 without considerably changing the home position covering the keyboard area. Nevertheless, the same operation can of course be also performed with a single hand.

Next, the operation in another application using the both hands according to this embodiment will be explained with reference to FIG. 12. FIG. 12 shows a program by which the color of the object 409 displayed at the lower right part of the display area 251 is changed by selecting a predetermined color from a menu window 410 displayed at the upper left part of the display area 251. FIG. 12A shows a state in which an object is selected, and FIG. 12B a state in which the color of the object 400 is changed to the color selected from the menu window 410.

The distance covered by the pointer is increased in the case where the object 409 is selected on the normal GUI screen and then an associated action is selected from the menu window 410. Assume, for example, that such a program is processed by the conventional mouse. First, the pointer is moved to the object 409 and a click button is depressed into select mode. Under this condition, the pointer is moved to the menu window 410 and the operating area for the intended color is required to be selected. In other words, after selecting the object 409 displayed at the lower right part of the display area 251, the pointer is required to be moved to the menu window 410 displayed at the upper left part of the display area 251.

In this process, the object 409 displayed at the lower right part of the display area 251 is selected with the right hand, while the menu window 410 displayed at the upper left part of the display area 251 is selected with the left hand, for example. This collaboration of the both hands can shorten the time required for the aforementioned operation without moving the fingers to a large measure. The present embodiment makes this collaboration possible.

For example, according to this embodiment, the touch area 400 corresponding to the object 409 displayed at the lower right part of the display area 251 is tapped with the right hand first of all, and then the touch area 400 corresponding to the menu window 410 (the operating area of the color to be selected) is tapped with the left hand. In this way, the color of the object can be changed. Specifically, according to this embodiment, the pointer is not required to be moved and therefore the operation can be accomplished within a short time. Further, according to this embodiment in which the movement of the pointer is not required, the touch area can be manipulated with the both hands. Thus, the operation can be carried out easily without changing the home position considerably.

### SECOND EMBODIMENT

FIGS. 13A to 19 show a desk-top information processing apparatus 10 (FIG. 15) of separated keyboard type according to a second embodiment.

First, referring to FIGS. 13A and 13B, the information processing apparatus 10 according to this embodiment will be explained. FIGS. 13A and 13B show the outer appearance of a keyboard 701 with a pointing device according to this embodiment. FIG. 13A is a perspective view showing the appearance of the keyboard 701, and FIG. 13B an exploded perspective view thereof. In FIGS. 13A and 13B, numeral 701 designates a keyboard with a pointing device, numeral 702 an infrared light frame, numeral 702a the upper surface thereof, numeral 703 a palm rest, numeral 703a the upper surface thereof, numeral 704 a key operating unit, numeral 705 a left click button, numeral 706 a right click button and numeral 707 a base.

The keyboard 701 with a pointing device according to this embodiment is configured of a combination of the infrared light frame 702, the palm rest 703 on which the hands are placed for operating the pointing device or keys, and the base 707 having the key operating unit 704 having various keys (not shown).

The infrared light frame 702 is combined with the palm rest 703 in such a manner that the upper surfaces 702a and 703a thereof are flat and substantially flush with each other. The base 707 is fitted into the combined structure of the infrared light frame 702 and the palm rest 703 from underside. With the infrared light frame 702, the palm rest 703 and the base 707 combined in this way, the key operating unit 704 on the base 707 is arranged inside of the infrared light frame 702. In spite of this, the height of the keys and the other parts of the key operating unit 704 is set in such a manner that the upper surfaces of the keys are lower than the upper surface 702a of the infrared light frame 702.

The left click button 705 and the right click button 706 are arranged on the part of the upper surface 702a of the infrared light frame 702 nearer to the palm rest 703. Nevertheless, the left click button 705 and the right click button 706 are not necessarily confined to these positions.

In the keyboard 701 with a pointing device configured as shown in FIG. 13A, for example, the palm of the right hand is placed on the palm rest 703 to manipulate the key operating unit 704, the left click button 705 and the right click button 706 inside of the infrared light frame 702 with the fingertips of the right hand. This operation is facilitated by the fact that the upper surface 702a of the infrared light frame 702 is substantially flush with the upper surface 703a of the palm rest 703.

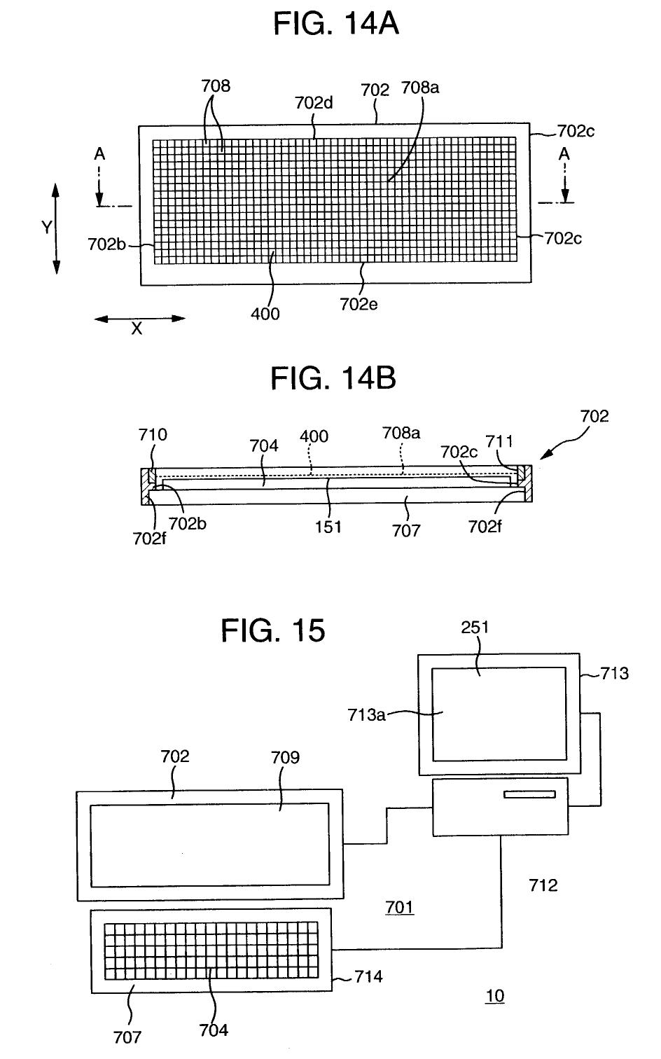

Next, a specific structure of an infrared light touch panel of the information processing apparatus 10 according to this embodiment will be explained with reference to FIGS. 14A and 14B. The infrared light touch panel employed in this embodiment can be constituted of a beam sensor 401 used for position detection based on the principle of triangulation as in the first embodiment described above. The present embodiment, however, employs the infrared light frame 702 covered with a grating of infrared light beams. FIGS. 14A and 14B are diagrams for explaining the infrared light beams in the infrared light frame 702 of the pointing device according to this embodiment. FIG. 14A is a top plan view, and FIG. 14B a sectional view taken in line A-A in FIG. 14A. Numerals 702b to 702e designate the inner side portions, numeral 702f depressions, numeral 708 infrared light beams, numeral 708a an infrared light grating, numeral 400 a touch area, numeral 710 an infrared light transmitting unit, and numeral 711 an infrared light receiving unit. The beam sensor 401a includes the transmitting unit 710, the receiving unit 711 and the pointing processing unit 406a not shown. The component parts corresponding to those in FIGS. 1A and 1B are designated by the same reference numerals, respectively.

In FIGS. 14A and 14B, a plurality of infrared light beams are passed in each of longitudinal and lateral directions inside of the infrared light frame 702. The position of the fingertip in touch-down operation crossing the infrared light beams is detected by the beam sensor 401a. The transmitting unit 710 includes a plurality of infrared light emitters arranged equidistantly from one end to the other of the inner side portion 702b constituting one of the two opposed inner side portions 702b, 702c of the infrared light frame 702. On the other hand, the receiving unit 711 includes a plurality of infrared light detectors arranged equidistantly from one end to the other of the other inner side portion 702c in one-to-one relation with the infrared light emitters arranged on the inner side portion 702b.

The same can be said also of the other two inner opposed side surface portions 702d, 702e of the infrared light frame 702. In a way similar to the inner side surface portion 702b, for example, the transmitting unit 710 having a plurality of infrared light emitters is arranged on the inner side surface portion 702d. In similar fashion, the receiving unit 711 having a plurality of infrared light detectors is arranged on the inner side surface portion 702e in a manner similar to the inner side surface portion 702c.

An infrared light beam 708 is emitted from each infrared light emitter of the transmitting unit 710 arranged on the inner side surface portion 702b. These infrared light beams are received by the receiving unit 711 having the corresponding infrared light detectors on the inner side surface portion 702c. In similar fashion, an infrared light beam 8 is emitted from each infrared light emitter 10 of the transmitting unit 710 arranged on the inner side surface portion 702d, and these infrared light beams are received by the receiving unit 711 having a plurality of corresponding infrared light detectors on the inner side surface portion 702e.

As a result, a plurality of the infrared light beams 708 emitted from the transmitting unit 710 arranged on the inner side surface portion 702b and a plurality of the infrared light beams 708 emitted from the transmitting unit 710 arranged on the inner side surface portion 702d cross each other. In this way, a touch area 400 including a plurality of infrared light meshes 708a arranged in a grating is formed on the inner side of the infrared light frame 702. These infrared light meshes 708a define the position on the inner side of the infrared light frame 702. According to this embodiment, the infrared light emitters are arranged at intervals of about 6 mm on the orthogonal two sides in the infrared light frame 702.

As shown in FIG. 14B, the base 707 is removably fitted in the depressions 702f formed in the lower surface side of the infrared light frame 702. At the same time, the keyboard area 151 having the key tops of the keys (not shown) of the key operating unit 704 on the base 707 is formed at a position lower than the touch area 400 having the infrared light meshes 708a.

The key operating unit 704 includes a flat and not curved keyboard area 151 having the key tops, and the distance (gap) between the touch area 400 including the infrared light meshes 708a and the keyboard area 151 is always maintained at a fixed length. According to this embodiment, the distance between the touch area 400 and the keyboard area 151 is set to not more than 1 mm, so that a finger touching the keyboard area 151 is detected by the beam sensor 401a.

This embodiment includes the transmitting unit 710 and the receiving unit 711 on the opposed sides of the infrared light frame 702. In spite of this, a pair of receiver/transmitters including the transmitting unit 710 and the receiving unit 711 can be arranged on adjacent sides of the infrared light frame 702 and a plurality of reflectors on the sides opposed to the sides having the receiver/transmitters. In this way, the wiring length can be reduced.

Next, a system configuration of the information processing apparatus 10 according to this embodiment will be explained with reference to FIG. 15. FIG. 15 is a diagram schematically showing a system configuration of the information processing apparatus 10 having a keyboard 701 with a pointing device. Numeral 712 designates a PC main unit, numeral 713 a display unit, numeral 713a a display screen, numeral 714 a keyboard and numeral 251 a display area.

In FIG. 15, the keyboard 714 including the key operating unit 704 and the base 707 (FIGS. 13, 14B) is connected to the keyboard terminal of the PC main unit 712. The infrared light frame 702 is connected to one of the USB terminal, the mouse terminal and the RS-232C terminal of the PC main unit 712. The cord from the keyboard 714 and the cord from the infrared light frame 702 may be combined and connected to a single terminal such as the USB terminal or the RS-232C terminal of the PC main unit 712.

According to this embodiment, the keyboard 701 is connected by PS/2, and the infrared light frame 702 is connected by RS-232C, to the PC main unit 712. Also, the size and the aspect ratio of the interior of the infrared light frame 702 are equal to those of the display area 251 of the 15-inch display unit 713. In the case where the 15-inch display unit 13 is used, therefore, the coordinate of a given point in the infrared light frame 702 and that of a given point on the display area 251 can be rendered to coincide almost completely with each other.

With the keyboard 701 with the pointing device according to this embodiment, assume that the fingertip is inserted into the touch area 400 of the infrared light frame 702 and touched down. At the touch-down position, the infrared light beams in both longitudinal and lateral directions are interrupted, with the result that the infrared light cannot be received by the X and Y infrared light detectors of the receiving unit 711 arranged at a position corresponding to the touch-down position. In this embodiment, the pointing processing unit 406a not shown detects the coordinate of the touch-down position from the X and Y directions detected by the receiving unit 711, and outputs the detected coordinate to the PC main unit 712. The coordinate information of the touch-down position detected in the touch area 400 and the image data displayed on the display area 251 are set in correspondence with each other by the PC main unit 712, and the pointer is displayed on the display area 251 accordingly.

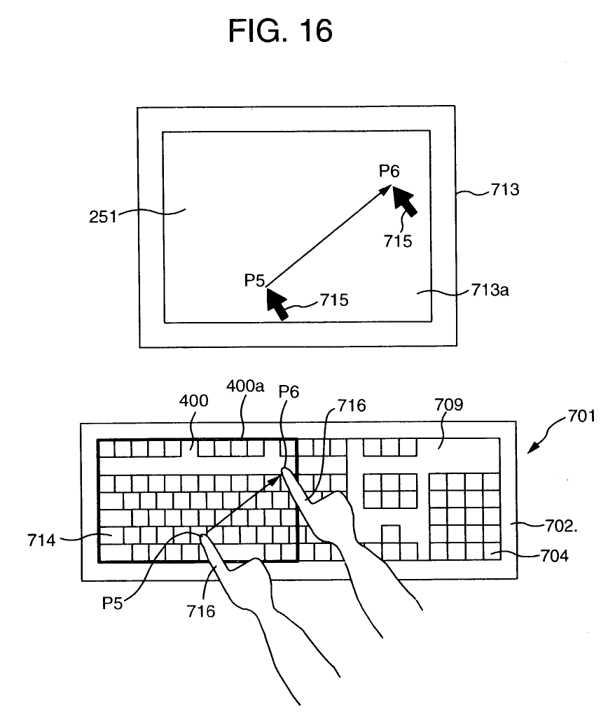

In the keyboard 701 with the pointing device according to the embodiment shown in FIG. 16, the infrared light frame 702 is combined with the keyboard 714 including the base 707 having thereon the key operating unit 704 with the ten-keys and the character input keys arranged thereon. In this embodiment, the keyboard 714 has many keys arranged longitudinally, and therefore, once the interior of the infrared light frame 702 is set in the touch area 400, it fails to register with the width of the display unit 713.

In this embodiment, the interior of the infrared light frame 702 is partly set as a touch area 400. According to this embodiment, in order to enable the operator to recognize the range of the touch area 400, a touch area designation frame 400a is described in a pattern or a designation line on the upper surface of the keyboard 714. The interior of the touch area designation frame 400a constitutes the touch area 400 configured of the infrared light grating 708.

As the result of the foregoing setting, the keyboard 701 with the pointing device is completed by combining a full keyboard having an arrangement of various keys with the infrared light frame 702. In this way, all the areas in the infrared light frame 702 are not defined as a part corresponding to the touch area 400, but only a part of the areas is defined as an area corresponding to the touch area 400, while the remaining part can be assigned to other functions. For example, a specific place in the infrared light frame 702 can be assigned with a frequently-used function button, or as in often the case with the track pad, the right end portion of the infrared light frame 702 is assigned as a longitudinal scroll area and the lower end thereof as a lateral scroll area.

According to this embodiment, as in the first embodiment, when a finger or the like touches down in the touch area 400, the position thus touched down is detected as a pointer display position. This will be explained in more detail with reference to FIG. 16. Numeral 715 designates a pointer, numeral 716 a fingertip, and numeral 717 a touch area 400. The component parts corresponding to those in FIG. 3 are designated by the same reference numerals, respectively.

According to this embodiment shown in FIG. 16, only the touch area designation frame 400a is set as a touch area 400. The touch area designation frame 400a may be plotted on the keyboard 714 or may be set as a given area colored with a predetermined color in the touch area designation frame 400a of the keyboard 714. In short, means is provided for clearly defining the touch area designation frame 400a. In the case under consideration, means is provided to pass the infrared light beams 708 from end to end both laterally and longitudinally in the touch area designation frame 400a. Thus, there is of course no requirement of the infrared light beams 708 which pass outside of the touch area designation frame 400a.

According to this embodiment, the operation similar to that of the first embodiment is possible. The description below is limited to basic operation, and will not be repeated.

### Pointer Display and Drag Operation (Simple Movement)

In the case where no touch-down occurs in the touch area 400, for example, the PC main unit 712 causes the pointer 714 to be displayed at the immediately preceding lift-off position. From this state, assume that the fingertip 16 touches down at the position p5 in the touch area 400. The PC main unit 712 (FIG. 15) detects the position p5 as a touch-down position, and causes the pointer 714 to move to the position P5 corresponding to the position p5 on the display screen 713a (display area 251) of the display unit 713. Under this condition (in touch-down state), also assume that the fingertip 716 is moved to the position p6 in the touch area 400. The PC main unit 712 (FIG. 15) traces and detects the process of movement from position p5 to position p6, and moves and displays the pointer 714 to and at the position P6 on the display screen 713a (display area 251) of the display unit 13. A lift-off at this position p6 causes the pointer 714 to be displayed directly at the position P6.

In this way, according to this embodiment, as in the first embodiment, the display position of the pointer 714 can be designated simply by inserting the fingertip 716 in the touch area 400. Upon this designation, the pointer 714 is displayed at the position on the display screen 13a (display area 251) corresponding to the designated position. Consequently, the operation is easy and a quick pointing operation becomes possible. Also, this designation job imparts no pressure on the fingertip 716. Even after the protracted operation, therefore, the fingertip is not fatigued nor feels a pain.

In the foregoing description, the position on the touch area 400 and the position on the display screen 713a are rendered to correspond in one-to-one relation with each other, so that the position of the pointer 714 displayed on the display screen 713a coincides with the position designated on the touch area 400. In the case where coincidence between the keyboard area 151 and the display screen 713a is difficult, for example, due to the fact that the display screen 713a is large as compared with the keyboard area 151, however, the two coordinate positions are not necessarily coincident with each other.

For example, such factors as the distance covered, the direction followed and the speed moved by the finger touched down and detected in the touch area 400 may be detected and in accordance with this detection of these factors, the relative movement of the pointer 714 displayed on the display screen 713a may be controlled. As an example, the higher is the speed of the touch-down finger or the like detected in the touch area 400, the larger is the motion of the pointer 714 set on the display screen 713. By so doing, the pointing operation and the key input operation can be performed without considerably changing the home position.

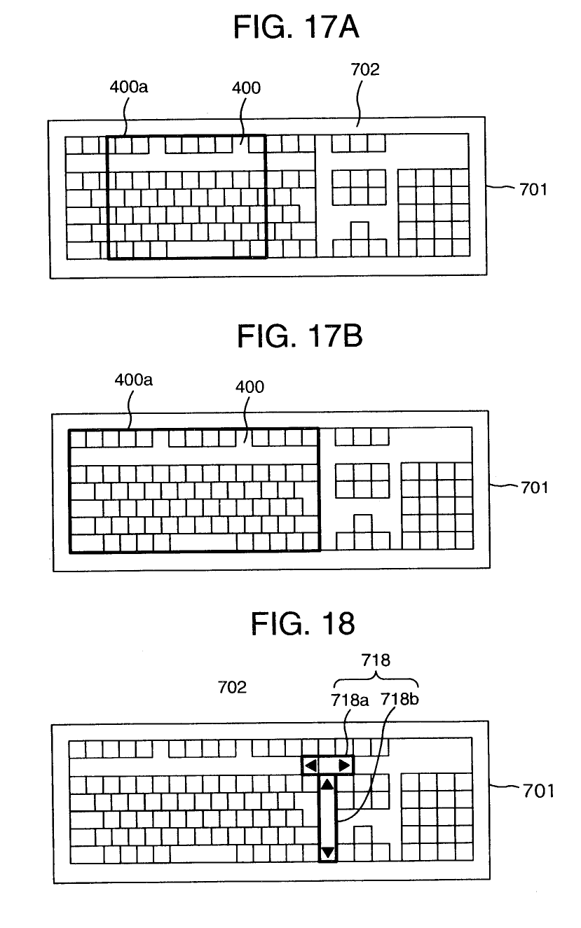

Next, the relation between the touch area designation frame 400a and the display screen 713a (display area 251) will be explained with reference to FIGS. 17A and 17B. FIGS. 17A and 17B are top plan views of the keyboard 701 with the pointing device for explaining another application of the touch area designation frame 400a. In FIGS. 17A and 17B, the touch area designation frame 400a may an area having the same aspect ratio as the display screen 713a of the display unit 13 as shown in FIG. 17A, or may have a longer lateral length than the aforementioned aspect ratio as shown in FIG. 17B. In the case where the touch area designation frame 400a has the same aspect ratio as the laterally long display screen 713a, the touch area 400 is also laterally long as shown in FIG. 17B.

As described above, the touch area designation frame 400a can be set or changed comparatively freely without considerably changing the design thereof, and therefore a superior versatility is achieved.

Next, the area for scroll operation will be explained with reference to FIG. 18. FIG. 18 is a top plan view of the keyboard 701 with a pointing device. In the foregoing description, the touch area designation frame 400a is for designating the display position of the pointer 714 (FIG. 16) directly. As an alternative, however, an operating area (scroll operating area) can be provided to scroll the display screen 713a. Further explanation will be made by referring to FIG. 18.

In this case, the scroll operating area 718 includes a laterally long operating area 718a for scrolling the whole screen or an active window (hereinafter referred to only as a screen) laterally in right or left direction and a longitudinally long operating area 718b for scrolling the screen longitudinally upward or downward on the display screen 713a (FIG. 15). The end portions of the operating areas 718a, 718b are each marked with an arrow indicating the direction of movement. The scroll operating area 718 may be usually but not necessarily formed between the keys in an area having the function keys of the keyboard 714. These operating areas 718a, 718b are colored for easy identification.

At least one lateral infrared light beam and a plurality of longitudinal infrared light beams (the lateral infrared light beam is not always required) are passed through the operating area 718a of the scroll operating area 718. Through the operating area 718b, on the other hand, at least one longitudinal infrared light beam and a plurality of lateral infrared light beams are passed (the longitudinal infrared light beam is not always required).

Suppose the fingertip is repeatedly moved rightward or leftward in such a manner as to cross the infrared light beams in the operating area 718a (hereinafter referred to as the touch movement). With the touch movement, the screen scrolls rightward or leftward. Specifically, in the case where the fingertip is subjected to touch movement repeatedly rightward or leftward in the operating area 718a, on the other hand, the screen scrolls rightward or leftward in response to the touch movement. In this way, the screen is scrolled on the display screen 713a. In accordance with the speed of fingertip movement, the scroll rate of the screen is changed. The higher the moving speed, the higher the rate at which the screen scrolls.

Instead of the touch movement of the fingertip as described, the arrow mark may be touched in the operating areas 718a, 718b to scroll the screen in the direction indicated by the arrow.

As described above, the screen can be scrolled without touching the operating member by the fingertip due to the scroll operating area 718. Even in the case where the scroll operation is protracted, therefore, no burden is imposed on the fingertip, which therefore is not fatigued nor feels any pain.

According to this embodiment, as shown in FIGS. 13A and 13B, the left and right click buttons 705, 706 are arranged on the upper surface 702a of the infrared light frame 702. For the left click operation, however, the left click button 705 is not necessarily provided, but the left click operation can be carried out by tapping the fingertip in such a manner as to cross the infrared light beams in an area (where at least a lateral infrared light beam is passing) outside of the touch area designation frame 400a of the touch area 400 as shown in FIG. 16.

### No Display of Pointer

Incidentally, according to the first embodiment, the pointer is not displayed for a predetermined time upon key input operation in the keyboard area 151 on the keyboard 150 thereby to prevent rapid movement of the pointer while the keys are operated. An alternative method intended to achieve the same effect will be explained below.

### Determination Based on Shield Area (Number of Beams)

(1) Method of determining whether the pointing operation is involved or not by the number of the infrared light meshes 708a (FIGS. 14A, 14B) touched by the fingertip.

When carrying out the pointing operation, as in the case b2 of FIG. 7B, the forward end portion of the fingertip enters the touch area 400. Therefore, the fingertip interrupts at most one each of the longitudinal infrared light beams 708 and the lateral infrared light beams 708, so that the fingertip position is detected by one infrared light mesh. In the case where the fingertip depresses a key as indicated by b3 in FIG. 7B, however, the fingertip enters the touch area 400 considerably and therefore interrupts a plurality of each of the longitudinal and lateral infrared light beams 708. According to this method, therefore, it is determined that the pointing operation is involved in the case where only one infrared light mesh 708a is touched by the fingertip, while it is determined that the key input operation is involved in the case where a plurality of the infrared light meshes 708a are touched. In the case where the interval between the infrared light beams is small, however, even the pointing operation may lead to the interruption of a plurality of infrared light beams, in which case the maximum number of infrared light beams for determining that the pointing operation is involved is set as a threshold value.

### Determination by Gesture

(2) Method of determining by gesture Upon key operation as indicated by b3 in FIG. 7B, the pointer is fixed or turned into non-display mode. To cancel this mode, a predetermined gesture is needed. For example, the same key is operated a plurality of times repeatedly at high speed, or a key-free part such as a space between the keys of the keyboard 714 (where infrared light beams are passing) is touched. By conducting any of these gestures, the fixed pointer turns to a movable state or the pointer that has thus far been invisible comes to be displayed.

The methods described above in (1) and (2) may be appropriately combined with the aforementioned method for determination by time.

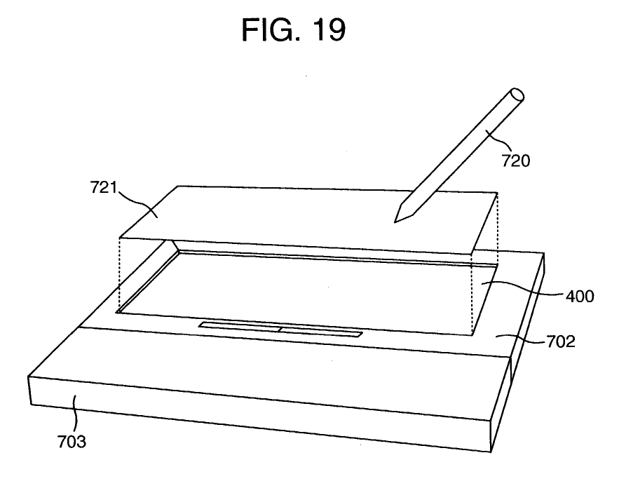

Next, with reference to FIG. 19, an explanation will be given of an embodiment in which the keyboard 701 with a pointing device is utilized as a pen tablet. FIG. 19 is a diagram for explaining the operation of the pen tablet. According to this embodiment, an illustration or the like can be plotted using the touch area 400 in the infrared light frame 702. In FIG. 15, the information processing apparatus 10 is turned into plot mode. Then, an illustration can be drawn on the display screen 713a of the display unit 713 with a pen in the touch area designation frame 400a as shown in FIGS. 17A, 17B. In this case, as shown in FIG. 19, a thin plate 721 of plastics or the like is fitted in the touch area designation frame 400a, and an illustration is plotted by the pen 720 on the thin plate 721.

The thin plate 721 is of course sufficiently thin to be located under the passage of the infrared light beam 708 as shown in FIG. 14 when fitted in the infrared light frame 702. Also, to facilitate removal from the infrared light frame 702 in which it is fitted, the width of the thin plate 721 is smaller than that of the infrared light frame 702. In this way, if the area on the thin plate 721 corresponding to the touch area 400 in FIGS. 17A and 17B is framed or colored, the plottable area on the thin plate 721 is clearly defined when the thin plate 721 is pressed against the left internal end of the infrared light frame 702.

Specifically, a pen-shaped rod (stylus) in place of a finger is held and traced over the keyboard surface. In the process, the pen can be smoothly moved by laying the thin plate 721 on the keyboard surface. In an assumed practical application, a keyboard and a pointing device are normally used, and only in the case where a free-hand plotting is needed, the thin plate 721 is covered for use as a tablet.

In the case of using a sensor with infrared light beams arranged in a grating, the smoothness of the lines plotted depends on the size of each grating unit and a smooth line may not be drawn. The use of the infrared light sensor of triangulation type explained in the first embodiment, however, makes it possible to draw a smooth line.

### THIRD EMBODIMENT

Next, another embodiment using the triangulation will be explained with reference to FIGS. 20A and 20B. FIGS. 20A and 20B are diagrams showing the essential parts of a keyboard with a pointing device according to another embodiment. FIG. 20A is a plan view, and FIG. 20B a sectional view taken in line B-B in FIG. 20A. Numeral 722 designates a laser emitter/detector, numeral 723 an invisible laser beam, numeral 724 a laser beam area, and numeral 725 a laser beam frame. The component parts corresponding to those explained in the second embodiment are designated by the same reference numerals, respectively, and will not be described again.

This embodiment is based on the method described in the article entitled “Tracking Hands Above Large Interactive Surfaces with a Low-Cost Scanning Laser Rangefinder” presented by J. Strickon & amp; J. Paradiso at “the ACM CHI '98 Conference”, April 21-23.

In FIGS. 20A and 20B, the laser beam frame 725 corresponds to the infrared light frame 702 in the aforementioned embodiments. In this embodiment, a laser beam is used instead of the infrared light beam, and therefore the laser beam frame 725 is employed.

A laser emitter/detector 722 including an emitter and a detector is arranged at one of the corners, e.g. at the upper left corner of the laser beam frame 725. The laser emitter/detector 722 emits an invisible laser beam 723 and receives the laser beam 723 after being reflected. The reciprocal rotation of the laser emitter/detector 722 over the range of about 90 degrees changes the direction of emission of the laser beam 723 over the whole interior of the laser beam frame 725. As a result, the laser beam area 724 in the laser beam frame 725 is swept in its entirety by the laser beam 723.

As long as the fingertip or the pen is not inserted in the laser beam area 724 and no touch operation performed, the laser beam 723 emitted from the laser emitter/detector 722 is mostly absorbed into the inner wall surface of the laser beam frame 725, and the reflected laser beam received by the laser emitter/detector 722 is not substantially detected. Once the touch operation is effected with the fingertip or the pen located at the position L in the laser beam area 724, however, the laser beam 723 emitted from the laser emitter/detector 722 is reflected from the particular fingertip or the pen, as the case may be, and the reflected laser beam is received by the laser emitter/detector 722 with a comparatively high strength. As a result, the touch operation is detected. From the rotational angle of the laser emitter/detector 722 and the phase difference (i.e. time difference) between the emitted laser beam and the received laser beam, the position L in the laser beam area 724 can be detected.

In this way, according to this embodiment, the touch position in the laser beam area 724 can be detected. The other configuration, operation and effects are similar to those of the embodiments described above.

Although the description of the aforementioned embodiments deals with an infrared light beam or an invisible laser beam, it is of course possible to use other invisible beams with equal effect.

### Other Applications

In spite of the aforementioned embodiments referring to the fact that a configuration of the display area 251 and the touch area 400 with the same width improves the blind operation, the relation between the display area 251 and the touch area 400 can be grasped more easily by such means as displaying a keyboard image as a background of the display area 251. By so doing, in the case where the object is superposed on the X key of the background keyboard image in the display area 251, for example, the operator can make sure that the particular object can be selected by tapping the X key. Incidentally, the visibility of the object to be displayed can be maintained by displaying a thin keyboard image on the background.

The foregoing description refers to a method in which a keyboard with a pointing device is used as an independent input device. Nevertheless, a mouse may be used with them. With this keyboard, the pointing position is designated using the absolute coordinate, and therefore the inching may not controlled easily. In the case where this control operation is required, therefore, a pointing device such as a mouse using the relative coordinate is effective. Specifically, although the key input/pointing operation is performed normally through the keyboard, a mouse is used as an auxiliary device only in the case where an inching operation is required.

It will thus be understood from the foregoing description that according to this invention, the operation is facilitated with a quick pointing operation and even after protracted use, no extra burden is imposed on the fingertip or the like of the operator.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An information processing apparatus comprising a storage unit, a processing unit, a display unit, and a keyboard including a plurality of keys;
wherein said keyboard has mounted thereon a beam sensor including a touch area formed by an invisible beam on said keyboard and a pointing processing unit for detecting the position designated by a designation member such as a finger inserted in said touch area, and
wherein said processing unit displays, in the display area of said display unit, a position corresponding to the position detected by said pointing processing unit.

2. An information processing apparatus according to claim 1, wherein the coordinate on said touch area and the coordinate on said display area correspond to each other with an absolute coordinate.

3. An information processing apparatus according to claim 1, wherein the width of said touch area is substantially equal to the width of said display unit.

4. An information processing apparatus according to claim 2, wherein the width of said touch area is substantially equal to the width of said display unit.

5. An information processing apparatus according to claim 1, wherein said beam sensor includes a pair of beam receiver/transmitters arranged at the right and left ends, respectively, of said keyboard on the side nearer to the operator for transmitting a beam in the direction toward the central depth and receiving the beam reflected by the reflection members arranged at the ends of said touch area.

6. An information processing apparatus according to claim 2, wherein said beam sensor includes a pair of beam receiver/transmitters arranged at the right and left ends, respectively, of said keyboard on the side nearer to the operator for transmitting a beam in the direction toward the central depth and receiving the beam reflected by the reflection members arranged at the ends of said touch area.

7. An information processing apparatus according to claim 3, wherein said beam sensor includes a pair of beam receiver/transmitters arranged at the right and left ends, respectively, of said keyboard on the side nearer to the operator for transmitting a beam in the direction toward the central depth and receiving the beam reflected by the reflection members arranged at the ends of said touch area.

8. An information processing apparatus according to claim 4, wherein said beam sensor includes a pair of beam receiver/transmitters arranged at the right and left ends, respectively, of said keyboard on the side nearer to the operator for transmitting a beam in the direction toward the central depth and receiving the beam reflected by the reflection members arranged at the ends of said touch area.

9. An information processing apparatus according to claim 1,
wherein the touch-down operation is performed for interrupting said invisible beams in said touch area by said designation member, and
wherein upon detection of the position of said interruption by said pointing processing unit, the pointer is moved to and displayed at the position on said display area corresponding to said detected position.

10. An information processing apparatus according to claim 1,
wherein the touch-down operation is performed for interrupting said invisible beams in said touch area by said designation member,
wherein upon execution of a lift-up operation for lifting up said designation member and restoring the state not interrupted by said invisible beams within a predetermined time following said touch-down operation, said processing unit recognizes said operation as a tap operation, and
wherein in the case where said tap operation is performed at a position corresponding to the object on said display area, said processing unit makes a display to the effect that said object has been selected.
